(19) United States
(12) Patent Application Publication
(10) Pub. No.: US 2021/0078756 A1
(43) Pub. Date: Mar. 18, 2021

(54) LEAK PROOF CONTAINER WITH PUSH LOCK BODY

(71) Applicant: INTERNATIONAL PAPER COMPANY, Memphis, TN (US)

(72) Inventors: MARK ANTHONY WISECARVER, MORRISTOWN, TN (US); JAMES WILLIAM SLOAN, II, EDGEFIELD, SC (US); KENNETH CALVIN HYATT, SPRINGDALE, AR (US)

(21) Appl. No.: 16/572,809

(22) Filed: Sep. 17, 2019

(51) Int. Cl. B65D 5/24; B65D 5/42; B65D 5/40; B31B 50/26; B31B 50/73

(52) U.S. Cl. CPC B65D 5/247; B65D 5/4279; B31B 2120/70; B31B 50/26; B31B 50/732; B65D 5/40

(57) ABSTRACT

A leak proof container and a method of forming the container from a blank. The blank includes a bottom panel, first and second side panels connected to the bottom panel at opposing lateral edges, and first and second end portions located at opposing longitudinal ends of the blank. Each end portion includes an inner end panel connected to the bottom panel, an outer end panel connected to the inner end panel, and first and second corner panels, each corner panel having an edge connected to a respective one of the first and second side panels and having an edge connected to the inner end panel. First and second locking tabs are defined in the outer end panel, each locking tab being defined by a lateral separation line located longitudinally inward from an outer longitudinal edge of the outer end panel and extending laterally to define a free tab end.

### FIELD OF THE INVENTION

The present disclosure relates to containers or trays formed from a blank of material and, more particularly, to a container that is formed with a leak proof construction for retaining moisture or fluid within the container.

### BACKGROUND OF THE INVENTION

In some applications of containers or trays formed of folded material such as paperboard material, e.g., corrugated paperboard, the container or tray may be configured to receive products having moisture or a fluid content that can leak into a base portion of the container or tray. In a known use of a container, a package containing protein parts of poultry may be supported within the container and the container can prevent leakage of fluids outside of the container.

For example, one known type of container can be formed from a blank of corrugated material wherein a bottom panel and a plurality of side panels may be formed of a unitary construction from a die cut and scored sheet of material. It is also known to provide such a container construction wherein the corners adjacent to the bottom are sealed. In such a container construction, the side panels can be integrally connected to the bottom panel along respective fold lines, and adjacent side panels can be connected by a folded gusset or web that is disposed at each corner to essentially configure the corners as leak proof connections between panels. While such container constructions can facilitate containing and handing of food products, such as in a food processing plant, one known problem that may be associated with leakproof containers is the potential of foreign object contamination. For example, in production processes for corrugated container blanks configurated and used for forming current leakproof containers, there is potential for corrugated trim to remain attached to the container blank. Hence, there remains a possibility that trim debris may release from a container to contaminate the container contents, such as when containers are assembled manually or mechanically and/or when containers are positioned in close relation to each other as trim falls in between stacked containers during manufacturing, wherein the trim can find its way into assembled boxes filled with product.

### SUMMARY OF THE INVENTION

In accordance with an aspect of the invention, a blank for making a leak proof container is described. The blank comprises a bottom panel having a plurality of peripheral edges. First and second side panels are connected to the bottom panel at opposing lateral peripheral edges and define lower edges of the container. First and second end portions are located at opposing longitudinal ends of the blank. Each end portion includes an inner end panel connected to a longitudinal peripheral edge of the bottom panel, an outer end panel having an inner longitudinal edge hingedly connected to a longitudinal edge of the inner end panel, first and second corner panels, each corner panel having a longitudinal edge connected to a respective one of the first and second side panels and a lateral edge connected to a lateral edge of the inner end panel. First and second locking tabs are defined in the outer end panel, each locking tab being defined by a lateral separation line located longitudinally inward from an outer longitudinal edge of the outer end panel and extending laterally to define a free tab end.

Each lateral separation line may be defined by a first, panel edge and a second, tab edge extending to an inner end of the lateral separation line.

The first, panel edge and the second, tab edge may be colinear to the lateral separation line.

A longitudinal separation line may extend longitudinally inward from the outer longitudinal edge of the outer end panel to each of the lateral separation lines, wherein the free ends of the tabs may be defined at the longitudinal separation lines.

The longitudinal and lateral separation lines may be defined by cut lines that extend completely through the outer end panel.

The longitudinal separation lines may angle laterally inward toward each other extending from the outer longitudinal edge of the outer end panel toward a respective lateral separation line.

The lateral separation lines may be spaced from the outer longitudinal edge of the outer end panel a distance that is less than a distance from the lateral separation lines to the inner longitudinal edge of the outer end panel.

The corner panels may be formed as square panels, and may include a diagonal fold line dividing each corner panel into first and second triangular gusset panels.

Each corner panel may include a lateral edge that is colinear with a lateral edge of the blank defined by an edge of one of the first and second side panels.

A longitudinal dimension of the outer end panel may be substantially less than a longitudinal dimension of the inner end panel.

In accordance with another aspect of the invention, a container is provided including a bottom panel defining a bottom of the container and having a plurality of peripheral edges. First and second side panels are connected to the bottom panel at opposing lateral peripheral edges and folded upward relative to the bottom panel. First and second end portions are located at opposing longitudinal ends of the blank. Each end portion includes an inner end panel connected to a longitudinal peripheral edge of the bottom panel, an outer end panel having an inner longitudinal edge hingedly connected to a longitudinal edge of the inner end panel, first and second corner panels, each corner panel including longitudinal and lateral edges connected to respective edges of a side panel and the inner end panel, each corner panel folded about a diagonal gusset fold line to define a gusset, and each gusset folded perpendicular to a respective side panel to overlapping relationship with the inner end panel, and first and second locking tabs defined in the outer end panel, each locking tab defined by a lateral separation line located longitudinally inward from an outer longitudinal edge of the outer end panel and extending laterally to define a free tab end. The outer end panel is folded about the inner longitudinal edge to overlapping relationship with at least a portion of each of the gussets, and the free tab ends are positioned between a respective gusset and the inner end panel to retain the outer end panel in position over the gussets.

Each lateral separation line may be defined by a first, panel edge and an adjacent second, tab edge extending to an inner end of the lateral separation line opposite the free end of the locking tab.

The first, panel edge and the second, tab edge may be collinear to the separation line.

The gusset fold line may intersect the first, panel edge and the second, tab edge at a common intersection point.

The gusset fold line may extend from the bottom of the container to the inner longitudinal edge of the outer end panel.

A longitudinal separation line may extend longitudinally inward from the outer longitudinal edge of the outer end panel to each of the lateral separation lines, wherein the free ends of the tabs may be defined at the longitudinal separation lines.

The outer longitudinal edge of the outer end panel may be located in spaced relation from the bottom of the container.

In accordance with a further aspect of the invention, a method of forming a container from a blank is provided. The blank comprises a bottom panel having a plurality of peripheral edges, first and second side panels connected to the bottom panel at opposing lateral peripheral edges and defining lower edges of the container, first and second end portions located at opposing longitudinal ends of the blank, each end portion including an inner end panel connected to a longitudinal peripheral edge of the bottom panel, an outer end panel having an inner longitudinal edge hingedly connected to a longitudinal edge of the inner end panel, first and second corner panels, each corner panel having a longitudinal edge connected to a respective one of the first and second side panels and a lateral edge connected to a lateral edge of the inner end panel, and first and second locking tabs defined in the outer end panel, and each locking tab defined by a lateral separation line extending to a free tab end. The method includes forming an end portion of the container comprising: folding the side panels and inner end panel upward from the bottom panel, and simultaneously folding each corner panel about a diagonal gusset fold line to define a gusset; folding each gusset perpendicular to a respective side panel to overlapping relationship with the inner end panel; folding the outer end panel about the inner longitudinal edge of the outer end panel to overlapping relationship with at least a portion of each of the gussets; and positioning the free tab ends between a respective gusset and the inner end panel to retain the outer end panel in position over the gussets.

Each lateral separation line may be defined by a first, panel edge and an adjacent second, tab edge extending to an inner end of the lateral separation line opposite the free end of the locking tab.

The gusset fold line may intersect the first, panel edge and the second, tab edge at a common intersection point.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a plan view of a blank for forming a leak proof container;

FIG. 2 is a perspective view of an initial step in folding the blank to erect the leak proof container;

FIG. 3 is a perspective view illustrating folding of gussets over an inner end panel of the container and positioning locking tabs adjacent to edges of the gussets;

FIG. 4 is a perspective view illustrating inserting the locking tabs behind the gussets to form an end of the container; and

FIG. 5 is a perspective view of the erected leak proof container.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

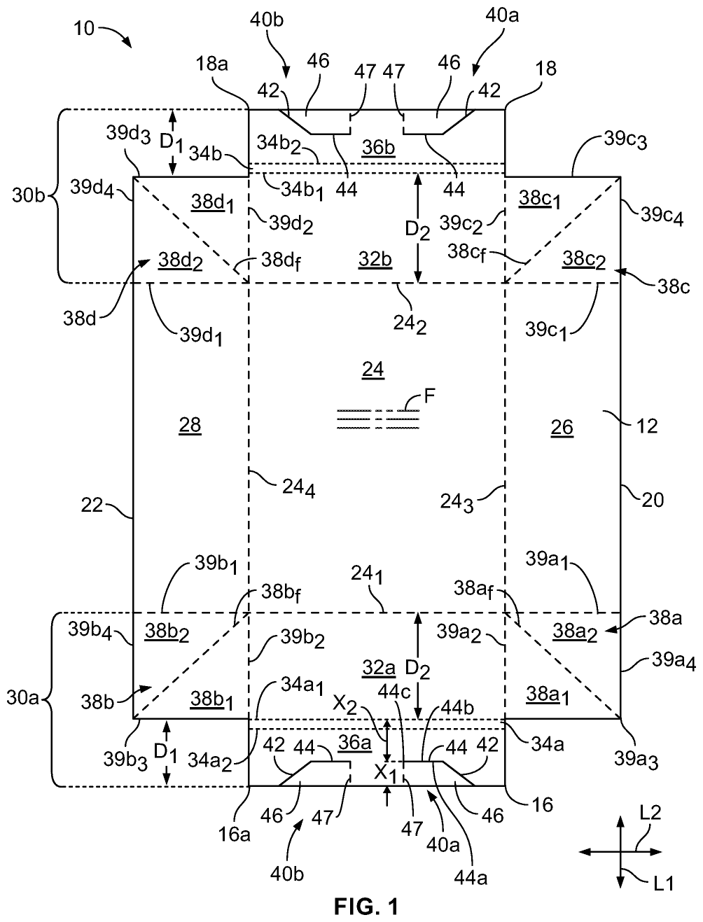

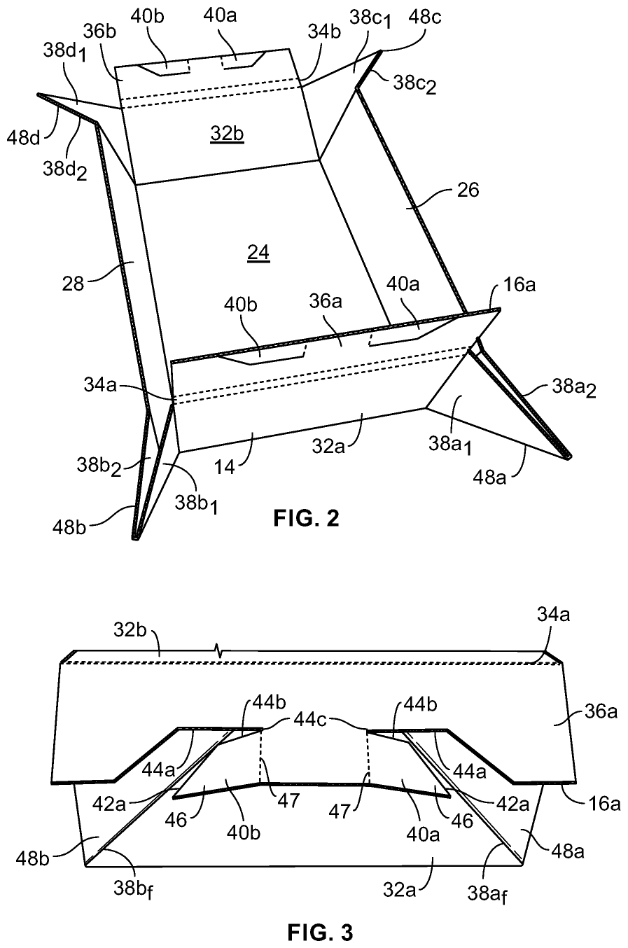

Referring to FIG. 1, a die cut blank 10 is shown for illustrating one or more aspects of a container or tray comprising a leak resistant container, as described herein. In a use of the blank 10 to form a one-piece leak proof container 8, see FIG. 5, the blank 10 may be formed of a corrugated cardboard material having an interior portion defined by elongated flutes, generally designated F in FIG. 1, as is generally known in the art, and may be die cut to the shape shown herein, although other materials and variations of the illustrated shape may be provided within the scope of the container described herein. The blank 10 illustrated in FIG. 1 is a planar piece of material in which an inner side 12 is shown facing out of the page and an outer side 14, see FIG. 2, faces in an opposite direction from the inner side 12.

As seen in FIG. 1, the blank 10 extends in a longitudinal direction L₁ between first and second longitudinal ends, generally designated 16 and 18, respectively, and further extends in a lateral direction L₂, perpendicular to the longitudinal direction L₁, between first and second lateral edges, generally designated 20 and 22, respectively. It may be noted that the flutes F extend in the lateral direction L₂.

The blank 10 comprises a bottom panel 24 having a plurality of peripheral edges 24₁, 24₂, 24₃, 24₄. A first side panel 26 is connected to the bottom panel 24 along a score line at the lateral peripheral edge 24₃, and a second side panel 28 is connected the bottom panel 24 along a score line at the opposing lateral peripheral edge 24₄. The peripheral edges 24₁, 24₂, 24₃, 24₄ define lower edges of the erected container 8.

First and second end portions 30a, 30b are located at the opposing longitudinal ends 16, 18 of the blank 10. Each end portion 30a, 30b includes a respective first and second inner end panels 32a, 32b connected to the longitudinal peripheral edges 24₁, 24₂ of the bottom panel 24 and extending between the lateral peripheral edges 24₃, 24₄. The first inner end panel 32a can include an outer longitudinal edge defined by a hinge portion 34a defined by a double score line 34a₁, 34a₂, and the second inner end panel 32b can include a hinge portion 34b defined by a double score line 34b₁, 34b₂. It should be understood that the inner end panels 32a, 32b may alternatively comprise hinge portions 34a, 34b defined by a single score line 34a₁, 34b₁.

The end portions 30a, 30b further include respective first and second outer end panels 36a, 36b. The first outer end panel 36a is hingedly joined to the first inner end panel 32a at the hinge portion 34a, and the second outer end panel 36b is hingedly joined to the second inner panel 32b at the hinge portion 34b. An inner longitudinal edge of the first outer end panel 36a can be connected to the first inner end panel 32a at the hinge portion 34a, and an outer longitudinal edge 16a of the first outer end panel 36a corresponds to the first longitudinal end 16 of the blank 10. An inner longitudinal edge of the second outer end panel 36b can be connected to the second inner end panel 32b at the hinge portion 34b, and an outer longitudinal edge 18a of the second outer end panel 36b corresponds to the second longitudinal end 18 of the blank 10. The first and second outer end panels 36a, 36b can be formed with a longitudinal dimension D₁ that is substantially less than a longitudinal dimension D₂ of the first and second inner end panels 32a, 32b.

The first end portion 30a additionally includes first and second corner panels 38a, 38b having inner longitudinal edges connected to the respective first and second side panels 26, 28 at score lines 39a₁, 39b₁ collinear with the longitudinal peripheral edge 24₁, and connected to the first inner end panel 32a at respective score lines 39a₂, 39b₂ collinear with the lateral peripheral edges 24₃, 24₄. The first and second corner panels 38a, 38b can each be formed with a square configuration having respective outer longitudinal edges 39a₃, 39b₃ collinear, or generally collinear with the outer longitudinal edge of the first inner end panel 32a, e.g., at the score line 34a₁, and having outer lateral edges 39a₄, 39b₄ collinear with the first and second lateral edges 20, 22, respectively. The first corner panel 38a additionally includes a score line defining a respective gusset fold line 38a_{f} extending diagonally across the corner panel 38a from an inner corner defined at an intersection of the score lines 39a₁ and 39a₂ to an intersection of the outer longitudinal edge 39a₃ and outer lateral edge 39a₄. Similarly, the second corner panel 38b additionally includes a score line defining a respective gusset fold line 38b_{f} extending diagonally across the corner panel 38b from an inner corner defined at an intersection of the score lines 39b₁ and 39b₂ to an intersection of the outer longitudinal edge 39b₃ and outer lateral edge 39b₄ The diagonal fold lines 38a_{f}, 38b_{f} divide the first and second corner panels 38a, 38b into first and second triangular gusset panels 38a₁, 38a₂ and 38b₁, 38b₂, respectively.

The second end portion 30b additionally includes first and second corner panels 38c, 38d having inner longitudinal edges connected to the respective first and second side panels 26, 28 at score lines 39c₁, 39d₁ collinear with the longitudinal peripheral edge 24₂, and connected to the first inner end panel 32b at respective score lines 39c₂, 39d₂ collinear with the lateral peripheral edges 24₃, 24₄. The first and second corner panels 38c, 38d can each be formed with a square configuration having respective outer longitudinal edges 39c₃, 39d₃ collinear, or generally collinear with the outer longitudinal edge of the second inner end panel 32b, e.g., at the score line 34b₁, and having outer lateral edges 39c₄, 39d₄ collinear with the first and second lateral edges 20, 22, respectively. The first corner panel 38c additionally includes a score line defining a respective gusset fold line 38c_{f} extending diagonally across the corner panel 38c from an inner corner defined at an intersection of the score lines 39c₁ and 39c₂ to an intersection of the outer longitudinal edge 39c₃ and outer lateral edge 39c₄. Similarly, the second corner panel 38d additionally includes a score line defining a respective gusset fold line 38d_{f} extending diagonally across the corner panel 38d from an inner corner defined at an intersection of the score lines 39d₁ and 39d₂ to an intersection of the outer longitudinal edge 39d₃ and outer lateral edge 39d₄ The diagonal fold lines 38c_{f}, 38d_{f} divide the first and second corner panels 38c, 38d into first and second triangular gusset panels 38c₁, 38c₂ and 38d₁, 38d₂, respectively.

The first outer end panel 36a includes a pair of laterally spaced tabs or tab structures 40a, 40b extending inward from the outer longitudinal edge 16a of the outer end panel 36a to form a push lock body for the first outer end panel 36a. Similarly, the second outer end panel 36b includes a pair of laterally spaced tab structures 40a, 40b extending inward from the outer longitudinal edge 18a of the outer end panel 36b to form a push lock body for the second outer end panel 36b.

Each tab structure 40a, 40b defines a locking tab and is defined by a longitudinal separation line 42 extending longitudinally inward from a respective outer longitudinal edge 16a, 18a, and a lateral separation line 44 located longitudinally inward from the respective longitudinal edge 16a, 18a and intersecting the longitudinal separation line 42 at a free end 46 of the tabs 40a, 40b, wherein laterally outer edges 42a of the tab ends 46 are defined at the longitudinal separation lines 42. The lateral separation lines 44 are spaced from the outer longitudinal edge 16a, 18a of a respective outer end panel 36a, 36b a distance X₁ that is less than a distance X₂ from the lateral separation lines 42 to the respective inner longitudinal ends, e.g., at the hinge portions 34a, 34b, of the outer end panel 36a, 36b. The longitudinal separation lines 42 on each outer end panel 36a, 36b angle laterally inward toward each other extending from the outer longitudinal edge 16a, 18a of the outer end panel 36a, 36b toward a respective lateral separation line 44. Further, a hinge connection is defined at a score line 47 between each tab structure 40a, 40b and a respective outer end panel 36a, 36b.

As is exemplified in FIG. 1 by the tab structure 40a on the outer end panel 36a, each lateral separation line 44 is defined by a first, panel edge 44a and a second, tab edge 44b extending to an inner end 44c of the lateral separation line 44, wherein the panel edge 44a and the tab edge 44b are colinear to the lateral separation line 44, such as may be defined by a straight common knife cut or area. The longitudinal separation line 42 and the lateral separation line 44 can be defined by cut lines, e.g., clean cut lines, that extend completely through the outer end panel 36a, 36b. However, it may be understood that the separation lines 42, 44 may also be defined by perforations that extend completely or partially through the outer end panels 36a, 36b.

Referring to FIGS. 2-5 a method of forming the blank 10 into an erected container 8 is described. The side panels 26, 28 and inner end panels 32a, 32b are initially folded upward from the bottom panel 24. Simultaneously, the corner panels 38a, 38b, 38c, 38d can be folded about respective gusset fold lines 38a_{f}, 38b_{f}, 38c_{f}, 38d_{f} to define gussets 48a, 48b, 48c, 48d. Subsequently, the gussets 48a, 48b, 48c, 48d can be folded perpendicular to a respective side panel 26, 28 into overlapping relationship with an inner end panel 32a, 32b, as illustrated by gussets 48a, 48b in overlapping relationship with the inner end panel 32a in FIG. 3. The configuration formed by the folded gussets 48a, 48b, 48c, 48d defines folded container corners that form a continuous connection between the side panels 26, 28 and the inner end panels 32a, 32b extending from the bottom panel 24 to an upper edge 50, see FIG. 5, of the container 8. Hence, the continuous configuration formed by the gussets 48a, 48b, 48c, 48d can prevent or substantially limit fluids from leaking out of the container 8 at junctions between the side panels 26, 28 and the inner end panels 32a, 32b.

In the position depicted in FIG. 3, the outer end panel 36a is pivoted about the inner longitudinal edge, i.e., at the hinge portion 34a, to a position outwardly spaced from the inner end panel 32a. The tab structures 40a, 40b are pivoted about the score lines 47 to locate the edges 42a of the tab ends 46 adjacent to the inner end panel 32a near the gusset fold lines 38a_{f}, 38b_{f} in preparation for positioning the tab ends 46 between the inner end panel 32a and the gussets 48a, 48b. It may be noted that the angled configuration of the edges 42a generally conforms to the angle of the gusset fold lines 38a_{f}, 38b_{f} which can minimize the pivoting of the tabs 40a, 40b at the score lines 47 as the edges 42a are located near the gusset fold lines 38a_{f}, 38b_{f}.

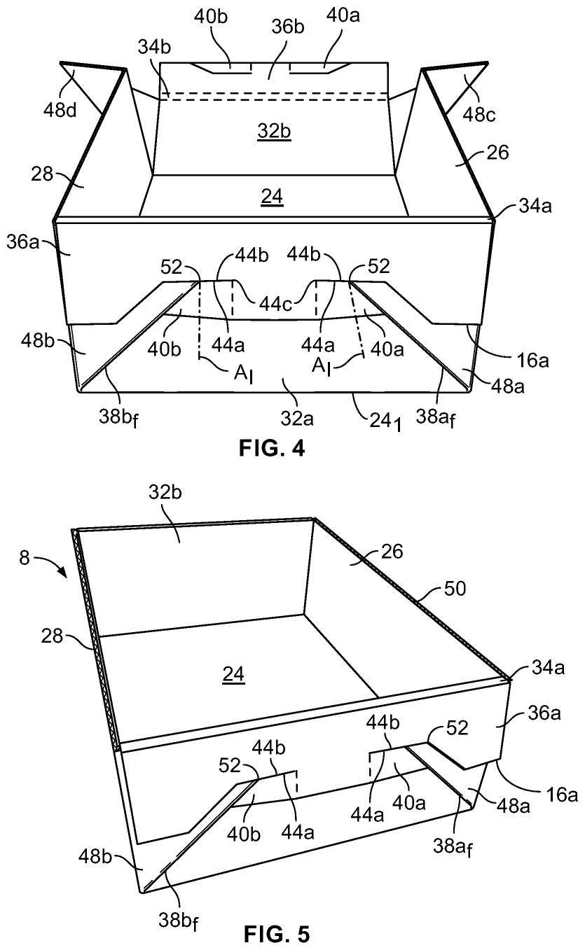

As seen in FIG. 4, the outer end panel 36a and tabs 40a, 40b can be pushed inward toward the inner end panel 32a to insert the tab ends 46 of the tabs 40a, 40b between the inner end panel 32a and the gussets 48a, 48b, defining an inserted position of the tabs 40a, 40b. In the inserted tab position, the gusset fold lines 38a_{f}, 38b_{f} intersect the respective adjacent panel edges 44a and tab edges 44b at a common intersection point 52, i.e. along a common intersection axis Ai. Each intersection point 52 defines a close fit between the gusset fold lines 38a_{f}, 38b_{f} and respective adjacent panel edges 44a and tab edges 44b, forming a tight locking structure for retaining the outer end panel 36a in close overlapping relation over the inner end panel 32a, as well as to retain the gussets 48a, 48b in their folded positions overlapping the inner end panel 32a.

It may be noted that the outer longitudinal edges 16a, 16b of the outer end panels 36a, 36b may be located in vertically spaced relation from the bottom 24 of the container, i.e., the peripheral edges 24₁, 24₂. For example, the outer end panels 36a, 36b may extend approximately half-way down the inner end panels 32a, 32b to reduce the material required for the outer end panel material while providing sufficient structure to the tabs 40a, 40b to form a relatively rigid locking structure for retaining the outer end panels 36a, 36b and gussets 48a, 48b, 48c, 48d in their folded position.

The inner end panel 32b, outer end panel 36b, and gussets 48c, 48d forming the opposing end of the container 8 can be folded in manner similar to that described above for the inner end panel 32a, outer end panel 36a, and gussets 48a, 48b to form the completed container 8, as illustrated in FIG. 5. The described container provides a configuration that can be readily assembled manually, with positively locking tab structures 40a, 40b that are conveniently manipulated to provide a securely constructed container. Also, it should be noted that, although the described construction of the container presents the gussets 48a, 48b, 48c, 48d being folded outward of the container, the gussets 48a, 48b, 48c, 40d may alternatively be folded inward to overlap respective inner sides of the inner end panels 32a, 32b and the outer end panels 36a, 36b may be folded inward to place the locking tab structures 40a, 40b on the inner side of the container.

It may be understood that, by forming the tabs 40a, 40b with the described separation lines 42, 44, without additional features such as cutouts or slots, the potential for debris created from such cutouts or slots is avoided. Specifically, the blank and associated container described herein can reduce the potential for trim debris within the blank area by providing a clean outside perimeter, with straight cuts, including straight common knife areas, and no internal trim areas. such as are described for the separation lines 42, 44. Hence, the configuration of the blank 10 and resulting container 8 can provide a container for food products that can avoid or substantially reduce contamination as a result of eliminating internal scrap areas, for example, eliminating the release of debris from the blank structure and/or when scrap is released but falls in between plural containers as they are stacked or otherwise grouped together.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A blank for making a leak proof container comprising:
a bottom panel having a plurality of peripheral edges;
first and second side panels connected to the bottom panel at opposing lateral peripheral edges and defining lower edges of the container;
first and second end portions located at opposing longitudinal ends of the blank, each end portion including:
an inner end panel connected to a longitudinal peripheral edge of the bottom panel;
an outer end panel having an inner longitudinal edge hingedly connected to a longitudinal edge of the inner end panel;
first and second corner panels, each corner panel having a longitudinal edge connected to a respective one of the first and second side panels and a lateral edge connected to a lateral edge of the inner end panel; and
first and second locking tabs defined in the outer end panel, each locking tab defined by a lateral separation line located longitudinally inward from an outer longitudinal edge of the outer end panel and extending laterally to define a free tab end.

2. The blank as set forth in claim 1, wherein each lateral separation line is defined by a first, panel edge and a second, tab edge extending to an inner end of the lateral separation line.

3. The blank as set forth in claim 2, wherein the first, panel edge and the second, tab edge are colinear to the lateral separation line.

4. The blank as set forth in claim 1, including a longitudinal separation line extending longitudinally inward from the outer longitudinal edge of the outer end panel to each of the lateral separation lines, wherein the free ends of the tabs are defined at the longitudinal separation lines.

5. The blank as set forth in claim 4, wherein the longitudinal and lateral separation lines are defined by cut lines that extend completely through the outer end panel.

6. The blank as set forth in claim 4, wherein the longitudinal separation lines angle laterally inward toward each other extending from the outer longitudinal edge of the outer end panel toward a respective lateral separation line.

7. The blank as set forth in claim 1, wherein the lateral separation lines are spaced from the outer longitudinal edge of the outer end panel a distance that is less than a distance from the lateral separation lines to the inner longitudinal edge of the outer end panel.

8. The blank as set forth in claim 1, wherein the corner panels are formed as square panels, and including a diagonal fold line dividing each corner panel into first and second triangular gusset panels.

9. The blank as set forth in claim 8, wherein each corner panel includes a lateral edge that is colinear with a lateral edge of the blank defined by an edge of one of the first and second side panels.

10. The blank as set forth in claim 1, wherein a longitudinal dimension of the outer end panel is substantially less than a longitudinal dimension of the inner end panel.

11. A container including a bottom panel defining a bottom of the container and having a plurality of peripheral edges, first and second side panels connected to the bottom panel at opposing lateral peripheral edges and folded upward relative to the bottom panel, first and second end portions located at opposing longitudinal ends of the blank, each end portion including:
an inner end panel connected to a longitudinal peripheral edge of the bottom panel;
an outer end panel having an inner longitudinal edge hingedly connected to a longitudinal edge of the inner end panel;
first and second corner panels, each corner panel including longitudinal and lateral edges connected to respective edges of a side panel and the inner end panel, each corner panel folded about a diagonal gusset fold line to define a gusset, and each gusset folded perpendicular to a respective side panel to overlapping relationship with the inner end panel;
first and second locking tabs defined in the outer end panel, each locking tab defined by a lateral separation line located longitudinally inward from an outer longitudinal edge of the outer end panel and extending laterally to define a free tab end; and
wherein the outer end panel is folded about the inner longitudinal edge to overlapping relationship with at least a portion of each of the gussets, and the free tab ends are positioned between a respective gusset and the inner end panel to retain the outer end panel in position over the gussets.

12. The container as set forth in claim 11, wherein each lateral separation line is defined by a first, panel edge and an adjacent second, tab edge extending to an inner end of the lateral separation line opposite the free end of the locking tab.

13. The container as set forth in claim 12, wherein the first, panel edge and the second, tab edge are collinear to the separation line.

14. The container as set forth in claim 13, wherein the gusset fold line intersects the first, panel edge and the second, tab edge at a common intersection point.

15. The container as set forth in claim 11, wherein the gusset fold line extends from the bottom of the container to the inner longitudinal edge of the outer end panel.

16. The container as set forth in claim 11, including a longitudinal separation line extending longitudinally inward from the outer longitudinal edge of the outer end panel to each of the lateral separation lines, wherein the free ends of the tabs are defined at the longitudinal separation lines.

17. The container as set forth in claim 11, wherein the outer longitudinal edge of the outer end panel is located in spaced relation from the bottom of the container.

18. A method of forming a container from a blank comprising a bottom panel having a plurality of peripheral edges, first and second side panels connected to the bottom panel at opposing lateral peripheral edges and defining lower edges of the container, first and second end portions located at opposing longitudinal ends of the blank, each end portion including an inner end panel connected to a longitudinal peripheral edge of the bottom panel, an outer end panel having an inner longitudinal edge hingedly connected to a longitudinal edge of the inner end panel, first and second corner panels, each corner panel having a longitudinal edge connected to a respective one of the first and second side panels and a lateral edge connected to a lateral edge of the inner end panel, and first and second locking tabs defined in the outer end panel, each locking tab defined by a lateral separation line extending to a free tab end, the method including forming an end portion of the container comprising:
folding the side panels and inner end panel upward from the bottom panel, and simultaneously folding each corner panel about a diagonal gusset fold line to define a gusset;
folding each gusset perpendicular to a respective side panel to overlapping relationship with the inner end panel;
folding the outer end panel about the inner longitudinal edge of the outer end panel to overlapping relationship with at least a portion of each of the gussets; and
positioning the free tab ends between a respective gusset and the inner end panel to retain the outer end panel in position over the gussets.

19. The method of forming a container as set forth in claim 18, wherein each lateral separation line is defined by a first, panel edge and an adjacent second, tab edge extending to an inner end of the lateral separation line opposite the free end of the locking tab.

20. The method of forming a container as set forth in claim 19, wherein the gusset fold line intersects the first, panel edge and the second, tab edge at a common intersection point.
